(19) United States
(12) Patent Application Publication
(10) Pub. No.: US 2025/0039710 A1
(43) Pub. Date: Jan. 30, 2025

(54) PREDICTION OF SUPERVISION FAILURES

(71) Applicant: Ademco Inc., Golden Valley, MN (US)

(72) Inventors: Nagaraj Chickmagalur Lakshminarayan, Bangalore Karnataka (IN); Shanmuga Prabhu, Tamil Nadu (IN)

(73) Assignee: Ademco Inc., Golden Valley, MN (US)

(21) Appl. No.: 18/716,816

(22) PCT Filed: May 19, 2022
(86) PCT No.: PCT/US2022/029955

§ 371 Date: Jun. 5, 2024

(30) Foreign Application Priority Data
Dec. 6, 2021 (IN) 202141056535

(51) Int. Cl. H04W 24/08; H04W 4/029; H04W 16/18

(52) U.S. Cl. CPC H04W 24/08; H04W 4/029; H04W 16/18

(57) ABSTRACT

Disclosed herein are techniques for detecting electromagnetic interference in a premise wireless network. A device determines (402) a scan value resulting from a network scan. The device compares (404) the scan value to a predetermined scan value threshold. In response to the scan value meeting the predetermined scan value threshold, the device determines (406) a presence of an electromagnetic interference source at or near a premise. The device generates (408) a premise map that includes an indication of a location at the premise of the electromagnetic interference source.

### TECHNICAL FIELD

The disclosure relates to networks, for instance, networks used in home automation, comfort, and security systems.

### BACKGROUND

A home network may use a wireless network protocol to connect devices within the home. For example, a hub device may use IEEE 802.15.4 to connect to over one hundred sensor devices in a home to the hub device. The hub device may then collect sensor data collected by the sensor devices in the home. For instance, the hub device may collect door/window, or other security or home automation, sensor readings and output the door/window, or other security or home automation, sensor readings to a home security sensor or other device in the home network or, in some cases, to a remote server. In another instance, the hub device may collect temperature readings from multiple temperature sensors arranged within the home and output the temperature readings to a thermostat that controls an HVAC system using the temperature readings.

### SUMMARY

In general, this disclosure relates to systems, devices, and methods for detecting potential or present electromagnetic interference(s) experienced by hub devices and/or sensor devices present on a local network. These hub devices and/or sensor devices communicate with one of the hub devices or an outside server device to transmit data experienced by the hub device or sensor device. This data can include various scan values that can be derived from any number of network scans amongst the devices connected to the local network. The device receiving this data (e.g., the hub device or the outside server device) can analyze this data by comparing the data to one or more predetermined thresholds for that data type. If the data indicates that there is electromagnetic interference present, or potentially present, the device can generate a premise map that includes an indication of the location of the present electromagnetic interference, such as by overlaying the premise map on a blueprint of the premise or by approximating the premise using sensor locations with respect to one of the hub devices.

Techniques described herein may improve a performance of a network. For example, a device that performs the prediction described herein may address potential issues in a local premise network that the user was previously unaware of. This may reduce the downtimes experienced when the failures ultimately occur, the time and effort to discover the interference after the occurrence of the failure, and the loss in efficiency experienced by the interference.

Furthermore, both an installer and a user can easily locate the source and location of electromagnetic interference when there is problem at a customer's location due to interference sources. For instance, a dealer can remotely check and solve the customer complaints, which can save cost and time. Additionally, electromagnetic interference can cause batteries in sensors and hubs to drain, meaning the techniques of this disclosure can allow these devices to avoid the fast draining of batteries by informing the user to move or remove the high interference sources from the affected zone area. Electromagnetic interference can also cause supervision failure, so the techniques described herein can identify and remove the interference source prior to experiencing critical supervision failures. The interference level can be easily visualized as a different zone category (e.g., low interference, medium interference, high interference, etc.) with available data. The techniques described herein also allow installers to run the interference diagnostic mode and find locations that have higher interference zones for certain durations of time (e.g., 24 hours).

One embodiment includes a method comprising a step of determining a scan value resulting from a network scan. The method further includes a step of comparing the scan value to a predetermined scan value threshold. The method also includes a step of, in response to the scan value meeting the predetermined scan value threshold, determining a presence of an electromagnetic interference source at or near a premise. The method further includes a step of generating a premise map that includes an indication of a location at the premise of the electromagnetic interference source.

In a further embodiment of the method, the scan value comprises one or more of a sensor device electromagnetic energy scan value, a hub device IEEE 802.11 detection scan value, and a hub device IEEE 802.15.4 detection scan value.

In a further embodiment of the method, the step of determining the scan value comprises performing one or more of a sensor device electromagnetic scan, a hub device IEEE 802.11 detection scan, and a hub device IEEE 802.15.4 detection scan.

In a further embodiment of the method, the method further includes a step of outputting, for display on a display device, a graphical indication of the premise map and the indication of the location at the premise of the electromagnetic interference source.

In a further embodiment of the method, the step of comparing the scan value to the predetermined scan value threshold comprises comparing, by a hub device, the scan value to the predetermined scan value threshold.

In a further embodiment of the method, the step of comparing the scan value to the predetermined scan value threshold comprises comparing, by a server device located outside of the premise, the scan value to the predetermined scan value threshold.

In a further embodiment of the method, the scan value comprises one or more of an indication of whether a sensor device lost synchronization and then later regained synchronization, a number of times the sensor device lost synchronization and then later regained synchronization, a number of non-TDMA messages detected at or near the premise, a number of free channels to which communication can be migrated to, and an energy level of channels different than a current channel over which communication is occurring.

In a further embodiment of the method the scan value comprises a first scan value resulting from a first network scan performed at a first time, and the method further includes a step of determining a second scan value resulting from a second network scan performed at a second time later than the first time. In this further embodiment, the method further includes a step of comparing the second scan value to the first scan value. In this further embodiment, the method also includes a step of, in response to the second scan value differing from the first scan value by a predetermined threshold amount, determining an increased presence of the electromagnetic interference source at or near the premise. In this further embodiment, the method further includes a step of generating the premise map that includes an indication of a location at the premise of the increased presence of the electromagnetic interference source.

In a further embodiment of the method, the method further includes a step of determining, based on the scan value, the location at the premise of the electromagnetic interference source.

In one such example of this further embodiment, the step of determining the location at the premise of the electromagnetic interference source comprises, when the scan value includes a sensor device electromagnetic energy scan value, determining a sensor device that was subjected to the network scan to produce the sensor device electromagnetic energy scan value, determining a location of the sensor device, and determining that the location at the premise of the electromagnetic interference source comprises the location of the sensor device.

In another such example of this further embodiment, the step of determining the location at the premise of the electromagnetic interference source comprises, when the scan value includes one or more of a hub device IEEE 802.11 detection scan value and a hub device IEEE 802.15.4 detection scan value, determining a hub device that was subjected to the network scan to produce the one or more of the hub device IEEE 802.11 detection scan value and the hub device IEEE 802.15.4 detection scan value, determining a location of the hub device, and determining that the location at the premise of the electromagnetic interference source comprises the location of the hub device.

In a further embodiment of the method, the predetermined scan value threshold comprises a low predetermined scan value threshold. In this further embodiment, the step of comparing the scan value to the predetermined scan value threshold comprises comparing the scan value to the low predetermined scan value threshold, comparing the scan value to a high predetermined scan value threshold, wherein the high predetermined scan value threshold is more extreme than the low predetermined scan value threshold, in response to the scan value meeting each of the low predetermined scan value threshold and the high predetermined scan value threshold, determining a presence of high electromagnetic interference at the electromagnetic interference source at or near the premise, and, in response to the scan value meeting the low predetermined scan value threshold and the scan value failing to meet the high predetermined scan value threshold, determining a presence of low electromagnetic interference at the electromagnetic interference source at or near the premise.

In one such example of this further embodiment, the method further includes a step of comparing the scan value to a medium predetermined scan value threshold, wherein the medium predetermined scan value threshold is between the low predetermined scan value threshold and the high predetermined scan value threshold. In this further embodiment, the method further includes a step of, in response to the scan value meeting each of the low predetermined scan value threshold and the medium predetermined scan value threshold and the scan value failing to meet the high predetermined scan value threshold, determining a presence of medium electromagnetic interference at the electromagnetic interference source at or near the premise.

Furthering this example, the step of determining the presence of the high electromagnetic interference comprises determining the presence of the high electromagnetic interference in response to the scan value meeting each of the low predetermined scan value threshold, the medium predetermined scan value threshold, and the high predetermined scan value threshold, and the step of determining the presence of the low electromagnetic interference comprises determining the presence of the low electromagnetic interference in response to the scan value meeting the low predetermined scan value threshold and the scan value failing to meet each of the medium predetermined scan value threshold and the high predetermined scan value threshold.

Furthering this example, the method further includes a step of generating the indication of the location at the premise of the electromagnetic interference source to graphically indicate whether the electromagnetic interference source is producing the low electromagnetic interference, the medium electromagnetic interference, or the high electromagnetic interference.

In a further embodiment of the method the premise includes a time division multiple access (TDMA) protocol-enabled wireless network.

Another embodiment includes a device comprising one or more communication units configured to receive, from a hub device of a premise wireless network, a scan value resulting from a network scan of the premise wireless network. The device further comprises one or more processors configured to compare the scan value to a predetermined scan value threshold, in response to the scan value meeting the predetermined scan value threshold, determine a presence of an electromagnetic interference source at or near a premise that includes the premise wireless network, and generate a premise map that includes an indication of a location at the premise of the electromagnetic interference source.

In a further embodiment of the device, the one or more communication units are further configured to send the premise map to the hub device for display on a display device operatively connected to the hub device.

Another embodiment includes a system comprising a plurality of sensor devices. The system further includes one or more hub devices including a first hub device. The first hub device is configured to determine a scan value resulting from a network scan. The first hub device is further configured to compare the scan value to a predetermined scan value threshold. The first hub device is also configured to, in response to the scan value meeting the predetermined scan value threshold, determine a presence of an electromagnetic interference source at or near a premise. The first hub device is further configured to generate a premise map that includes an indication of a location at the premise of the electromagnetic interference source.

In a further embodiment of the system, the scan value comprises one or more of a sensor device electromagnetic energy scan value for a first sensor device of the plurality of sensor devices, a hub device IEEE 802.11 detection scan value for one of the one or more hub devices, and a hub device IEEE 802.15.4 detection scan value for one of the one or more hub devices.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present invention and therefore do not limit the scope of the invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1 is a conceptual diagram illustrating an example system for detecting electromagnetic interference, in accordance with some examples of this disclosure.

FIG. 2A is a conceptual block diagram illustrating an example of a home network, in accordance with some examples of this disclosure.

FIG. 2B is a conceptual block diagram illustrating a computing device in greater detail, in accordance with some examples of this disclosure.

FIG. 3 is a conceptual diagram illustrating an example premise map, in accordance with some examples of this disclosure.

FIG. 4 is a flow diagram illustrating a method, in accordance with some examples of this disclosure.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Modern residential buildings or other buildings may include a central “hub” device configured to manage one or more systems within the building, such as monitoring systems, comfort systems, security systems, and/or home automation systems. The hub device can be in wireless communication with a number of other devices placed throughout the building. For example, the hub device may wirelessly receive sensor data from any number of different sensor devices, such as motion sensors, air quality and/or temperature sensors, infrared sensors, door and/or window contact sensors, switches, and/or other sensor devices. Additionally, the hub device may wirelessly transmit commands or instructions to one or more controllable sensor devices. For example, the hub device may instruct a thermostat to adjust a temperature within the building, or in another example, may command a damper to open or close an air vent.

In some applications for managing one or more systems within a building, BLUETOOTH radio communication techniques may have an advantage over other radio connection techniques such as, for example, IEEE 802.15.4 radio communication techniques. For instance, BLUETOOTH radio communications techniques may support high data rates and throughput compared to IEEE 802.15.4 radio communication techniques. For example, BLUETOOTH may have a bandwidth of greater than 500 kilobits-per-second (kbps) (e.g., 1 Mbps) and IEEE 802.15.4 may have a bandwidth of less than 500 kbps (e.g., 250 kbps). From a range perspective, BLUETOOTH radio techniques and IEEE 802.15.4 radio communication techniques may have nearly equal link budget. BLUETOOTH may have a range of greater than 80 meters (e.g., 100) meters) and IEEE 802.15.4 may have a range of less than 80 meters (e.g., 70 meters). In some examples, BLUETOOTH may have a join time (e.g., latency) of greater than 1 second (e.g., 3 seconds) and IEEE 802.15.4 may have a join time of less than 1 second (e.g., 30 milliseconds (ms)). BLUETOOTH may have a stack size of greater than 100 kb (e.g., 250 kb) and IEEE 802.15.4 may have a stack size of less than 100 kb (e.g., 28 ms). In some examples, IEEE 802.11, also referred to herein as simply “Wi-Fi™,” may offer even higher data rates than BLUETOOTH but with a higher energy cost.

As used herein, BLUETOOTH may refer to present and future versions of BLUETOOTH. Examples of BLUETOOTH include classic BLUETOOTH (e.g., Versions 1.0, 1.0B, 1.1, 1.2, 2.0, 2.1, 3.0, 4.0, 4.1, 4.2, 5, 5.1, etc.), BLUETOOTH-low energy (e.g., Versions 4.0, 4.1, 4.2, 5, 5.1, etc.), and other types of BLUETOOTH. As such, all instances of “BLUETOOTH” herein should be interpreted as including classic BLUETOOTH and/or BLUETOOTH-low energy. BLUETOOTH may operate at frequencies between 2.402 and 2.480 GHZ, 2.400 and 2.4835 GHz including a 2 MHZ wide guard band and a 3.5 MHz wide guard band, or another frequency range. In some examples, each frequency channel of the BLUETOOTH channel may have a center frequency different from a central frequency of a neighboring channel by less than 1 MHz. In some examples, each frequency channel of a wireless channel (e.g., an IEEE 802.15.4 channel) may have a center frequency different from a central frequency of a neighboring channel by greater than 1 MHZ (e.g., 2 MHZ, 5 MHZ, etc.).

Smart home devices may deploy many different wireless protocols to address the needs to the smart home. There are standards based protocols (Wi-Fi™, Zigbee™, Thread™, Zwave™, BLUETOOTH, DECT™, etc.) and proprietary, manufacture specific protocols. The issue with this array of protocols is that each protocol is tuned to a specific application. For example, Wi-Fi™ may be particularly useful for high bandwidth data applications that do not require long battery life. Zigbee™ may be particularly useful for low bandwidth data applications to maximize battery life. Additionally, not every wireless protocol is globally compliant. For example, Zwave™ may have different hardware designs for various operational regions.

Smart home systems may include a collection of different networks that operate at a common frequency suitable for home networks. For example, a Wi-Fi™ network of a smart home system, a BLUETOOTH network of the smart home system, and an IEEE 802.15.4 network of the smart home system may each operate at a 2.4 GHz frequency.

Smart home systems face numerous difficulties. When there is a source of interference in an operating channel of a wireless network, sensors may struggle to communicate with a hub device. This can lead to early battery drain, as the sensors will continue operating throughout frequent beacon loss and sync loss (e.g., 8 consecutive lost beacons may be equivalent to 1 synchronization loss). An operating channel may change using a frequency agility mechanism when the interference is detected either by a sensor or a hub device, but this may not be the case when a number of interference sources are surrounded by sensors and a hub device. When interference is present, it typically requires a servicer to visit the customer's physical location and investigate the premise in order to determine what may be the cause of the interference.

In accordance with the techniques of the disclosure, a device may determine a scan value resulting from a network scan, either by performing the network scan itself or by receiving the value from a separate device that conducted the network scan. The device may compare the scan value to a predetermined scan value threshold corresponding to the type of the scan value. In response to the scan value meeting the predetermined scan value threshold, the device determines a presence of an electromagnetic interference source at or near a premise. The device generates a premise map that includes an indication of a location at the premise of the electromagnetic interference source.

Techniques described herein may improve a performance of a network. For example, a device that performs the prediction described herein may address potential issues in a local premise network that the user was previously unaware of. This may reduce the downtimes experienced when the failures ultimately occur, the time and effort to discover the interference after the occurrence of the failure, and the loss in efficiency experienced by the interference.

Furthermore, both an installer and a user can easily locate the source and location of electromagnetic interference when there is problem at a customer's location due to interference sources. For instance, a dealer can remotely check and solve the customer complaints, which can save cost and time. Additionally, electromagnetic interference can cause batteries in sensors and hubs to drain, meaning the techniques of this disclosure can allow these devices to avoid the fast draining of batteries by informing the user to move or remove the high interference sources from the affected zone area. Electromagnetic interference can also cause supervision failure, so the techniques described herein can identify and remove the interference source prior to experiencing critical supervision failures. The interference level can be easily visualized as a different zone category (e.g., low interference, medium interference, high interference, etc.) with available data. The techniques described herein also allow installers to run the interference diagnostic mode and find locations that have higher interference zones for certain durations of time (e.g., 24 hours).

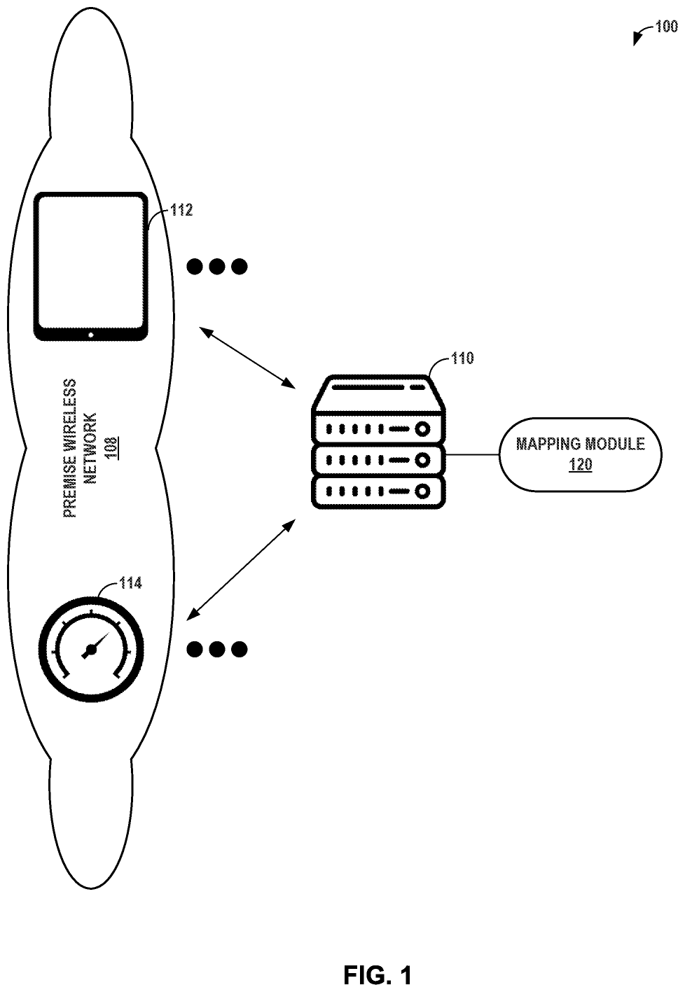

FIG. 1 is a conceptual diagram illustrating an example system for detecting electromagnetic interference, in accordance with some examples of this disclosure. System 100 may include a variety of devices, including computing device 110, one or more hub devices 112, and one or more sensor devices 114.

Computing device 110 may be any computer with the processing power required to adequately execute the techniques described herein. For instance, computing device 110 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein. In many examples, computing device 110 may be one of hub devices 112 or may be a remote server device configured to communicate with hub devices 112 and sensor devices 114.

Computing device 110 may include mapping module 120. Mapping module 120 may execute locally (e.g., at processors 240) to provide functions associated with analyzing scan values to determine whether there is a presence of electromagnetic interference somewhere within premise wireless network 108. In some examples, mapping module 120 may act as an interface to a remote service accessible to computing device 110. For example, prediction module 120 may be an interface or application programming interface (API) to a remote server that determines the presence of the electromagnetic interference.

Each of hub devices 112 may be any computing device, including tablet computers or centralized panels, that are configured to coordinate the other devices in system 100. For instance, one of hub devices 112 may receive user input to control some aspect of one or more of the sensor devices 114. Hub devices 112 may also relay audio or visual output from sensor devices 114, or indications of failure determined by computing device 110, to the user in order to provide feedback regarding the system, such as alarm events or status updates.

Sensor devices 114 may include any sensors that could be placed in a smart home system, including thermostats, indoor motion sensors, outdoor motion sensors, door and window contact sensors, air vent dampers, smart doorbells, outdoor air sensors, outdoor infrared sensors, indoor infrared sensors, routers, mobile devices, a security device, a water heater, a water flow controller, a garage door controller, a motion passive infrared (PIR) sensor, a mini contact sensor, a key fob, a smoke detector, a glass break detector, a siren, a combined smoke detector and Carbon monoxide (CO) detector, an indoor siren, a flood sensor, a shock sensor, an outdoor siren, a CO detector, a wearable medical pendant, a wearable panic device, an occupancy sensor, and a keypad, among other things.

Premise wireless network may include hub devices 112 and sensors 114. In some instances, premise wireless network 108 may also include computing device 110. In other instances, premise wireless network 108 may be configured to communicate with computing device 110, which is located on a separate network. Premise wireless network may be any piece of infrastructure that facilitates communication between devices, including WiFi®, BLUETOOTH, Zigbee®, or any other wireless or wired communication technology. In some instances, premise wireless network 108 and one or more devices on premise wireless network 108 may be configured to communicate using a time division multiple access (TDMA) protocol.

In accordance with the techniques described herein, computing device 110 may determine a scan value resulting from a network scan of premise wireless network 108. If computing device 110 is local to premise wireless network 108, computing device 110 may perform the network scan itself. If computing device 110 is a remote server device, one of hub devices 112 may perform the network scan on premise wireless network 108 and forward the scan value resulting from the network scan to computing device 110. Mapping module 120 may compare the scan value to a predetermined scan value threshold. In response to the scan value meeting the predetermined scan value threshold, mapping module 120 may determine a presence of an electromagnetic interference source at or near a premise. Mapping module 120 may generate a premise map that includes an indication of a location at the premise of the electromagnetic interference source.

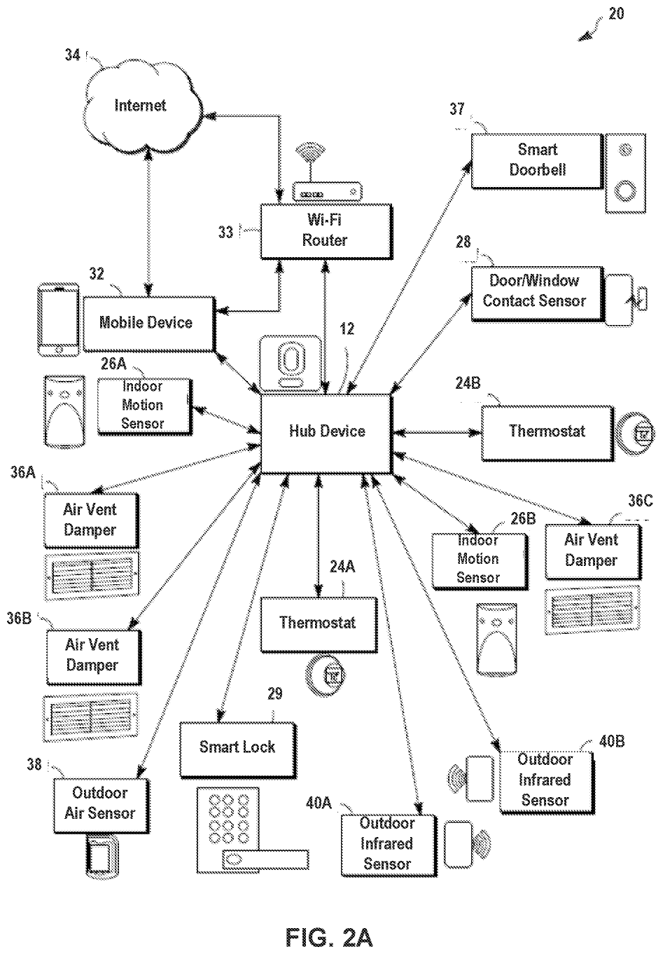

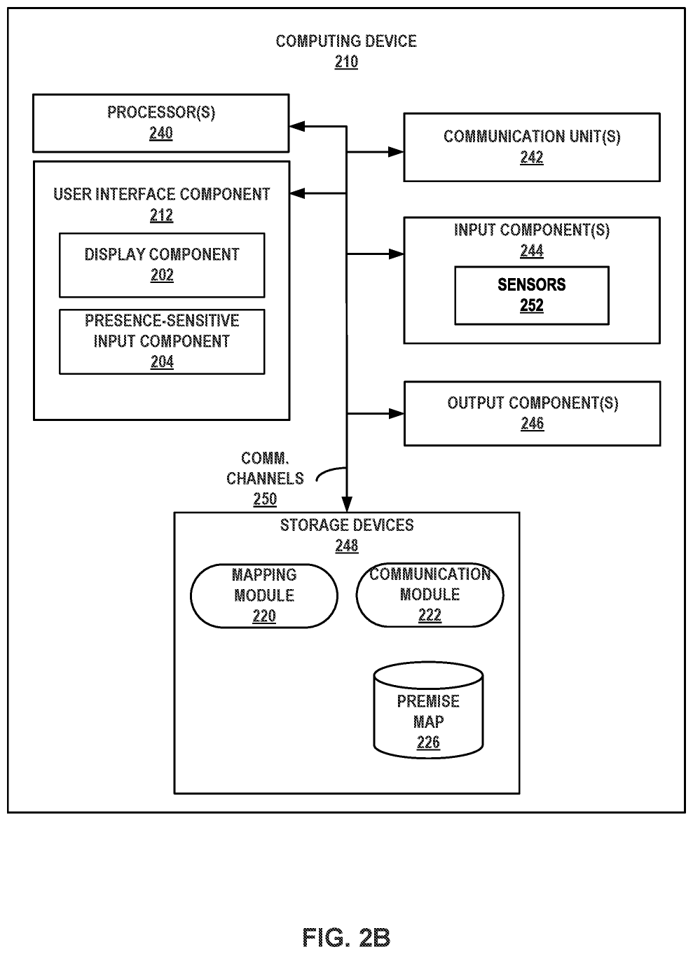

FIG. 2A is a conceptual block diagram illustrating a networked system 20, which may be one example of the networked system 10 of FIG. 1, in accordance with some examples of this disclosure. System 20 includes hub device 12, thermostat 24A, thermostat 24B (collectively, thermostats 24), indoor motion sensor 26A, outdoor motion sensor 26B (collectively, motion sensors 26), door/window contact sensor 28, air vent damper 36A, 36B, 36C (collectively, air vent dampers 36), smart doorbell 37, outdoor air sensor 38, outdoor infrared sensor 40A, indoor infrared sensor 40B (collectively, infrared sensors 40), router 33, and mobile device 32. Hub device 12 and one or more of the devices in the networked system 20 can communicate using a first frequency band (e.g., 2.4 GHZ) and/or a second, different frequency band (e.g., sub 1 GHz). For example, at least one device in the networked system 20 can communicate with hub device 12 using the first frequency band while at least one other device in the networked system 20 can communicate with hub device 12 using the second, different frequency band. In another example, at least one device in the networked system 20 can selectively communication with hub device 12 using one of the first frequency band and the second, different frequency band as selected for a specific superframe. While hub device 12 is shown as a distinct component, hub device 12 may be integrated into one or more of thermostats 24, motion sensors 26, door/window contact sensor 28, air vent dampers 36, smart doorbell 37, outdoor air sensor 38, and infrared sensors 40. The various devices of system 20 are for example purposes only. For example, additional devices may be added to system 20 and/or one or more devices of system 20 may be omitted.

The system 20 is a non-limiting example of the techniques of this disclosure. Other example systems may include more, fewer, or different components and/or devices. While FIG. 2A illustrates a mobile phone, mobile device 32 may, in some examples, include a tablet computer, a laptop or personal computer, a smart watch, a wireless network-enabled key fob, an e-readers, or another mobile device. Mobile device 32 and/or router 33 may be connected to a wide area network, such as, for example, internet 34. Internet 34 may represent a connection to the Internet via any suitable interface, such as, for example, a digital subscriber line (DSL), dial-up access, cable internet access, fiber-optic access, wireless broadband access, hybrid access networks, or other interfaces. Examples of wireless broadband access may include, for example, satellite access, WiMax™, cellular (e.g., 1×, 2G, 3G™, 4G™, 5G™, etc.), or another wireless broadband access.

Central hub device 12 may be in wireless data communication with thermostats 24, motion sensors 26, door/window contact sensor 28, air vent dampers 36, smart doorbell 37, outdoor air sensor 38, and infrared sensors 40. For example, thermostats 24, motion sensors 26, door/window contact sensor 28, air vent dampers 36, smart doorbell 37, outdoor air sensor 38, and infrared sensors 40 may be directly connected to hub device 12 using one or more wireless channels according to a connection protocol, such as, but not limited to, for example, IEEE 802.15.4, BLUETOOTH, or another connection protocol.

Each of thermostats 24, motion sensors 26, door/window contact sensor 28, air vent dampers 36, smart doorbell 37, outdoor air sensor 38, and infrared sensors 40 may include either a sensor device (e.g., a device configured to collect and/or generate sensor data), a controllable device, or both, as described herein. For example, thermostats 24 may include comfort devices having sensors, such as a thermometer configured to measure an air temperature. In some examples, air vent dampers 36 may include devices located within an air vent or air duct, configured to either open or close the shutters of an air vent in response to receiving instructions from hub device 12.

Although not shown in the example of FIG. 2A, central hub device 12 may be in indirect wireless data communication (e.g., communication via a repeater node) with one or more of thermostats 24, motion sensors 26, door/window contact sensor 28, air vent dampers 36, smart doorbell 37, outdoor air sensor 38, and infrared sensors 40. For example, outdoor air sensor 38 may be indirectly connected thermostat to hub device 12 using a wireless channel according to a connection protocol, such as, but not limited to, for example, IEEE 802.15.4, BLUETOOTH, or another connection protocol. For instance, outdoor air sensor 38 may be connected to hub device 12 via thermostat 24A, outdoor infrared sensor 40A may be connected to hub device 12 via outdoor motion sensor 26B, etc.

Thermostats 24 may be configured to wirelessly transmit the temperature (e.g., sensor data) directly to hub device 12. Additionally, thermostats 24 may include controllable devices, in that they may activate or deactivate a heating, cooling, or ventilation system in response to receiving instructions from hub device 12. For example, thermostat 24A may collect temperature data and transmit the data to hub device 12. Hub device 12, in response to receiving the temperature data, may determine that a respective room is either too hot or too cold based on the temperature data, and transmit a command to thermostat 24A to activate a heating or cooling system as appropriate. In this example, each of thermostats 24 may include both sensor devices and controllable devices within a single distinct unit.

Indoor and outdoor motion sensors 26 may include security devices configured to detect the presence of a nearby mobile object based on detecting a signal, such as an electromagnetic signal, an acoustic signal, a magnetic signal, a vibration, or other signal. The detected signal may or may not be a reflection of a signal transmitted by the same device. In response to detecting the respective signal, motion sensors 26 may generate sensor data indicating the presence of an object, and wirelessly transmit the sensor data to hub device 12. Hub device 12 may be configured to perform an action in response to receiving the sensor data, such as outputting an alert, such as a notification to mobile device 32, or by outputting a command for the respective motion sensor 26 to output an audible or visual alert. In this example, each of motion sensors 26 may include both sensor devices and controllable devices within a single unit.

Door and/or window contact sensor 28 may include a security device configured to detect the opening of a door or window on which the door and/or window contact sensor 28 is installed. For example, contact sensor 28 may include a first component installed on a door or window; and a second component installed on a frame of the respective door or window. When the first component moves toward, past, or away from the second component, the contact sensor 28 may be configured to generate sensor data indicating the motion of the door or window, and wirelessly transmit the sensor data to hub device 12. In response to receiving the sensor data, hub device may be configured to perform an action such as outputting an alert, such as a notification to mobile device 32, or by outputting a command for the respective contact sensor 28 to output an audible or visual alert. In this example, contact sensor 28 may include a sensor devices and a controllable devices within a single unit.

Air vent dampers 36 may be configured to regulate a flow of air inside of a duct. For example, thermostats 24 may generate a control signal to close air vent damper 36A (e.g., when the room is not occupied). In this example, in response to the control signal, air vent damper 36 may close to prevent air from flowing from air vent damper 36A. In some examples, air vent dampers 36 may send sensor data indicating a state (e.g., open or closed) of the respective air vent damper. For instance, air vent damper 36 may output, to thermostats 24 an indication that air vent damper 36 is in an open state.

Smart doorbell 37 may be configured to provide notifications to hub device 12. For example, smart doorbell 37 may be configured to provide a notification (e.g., message) when a button (e.g., doorbell) of smart doorbell 37 is activated. In some examples, smart doorbell 37 may include motion sensor circuitry configured to generate a notification in response to motion detected near smart doorbell 37. In some examples, smart doorbell 37 may be configured to generate video content in response to motion detected near smart doorbell 37. In some examples, smart doorbell 37 may be configured to generate audio content in response to motion detected near smart doorbell 37. For instance, in response to motion detected near smart doorbell 37, smart doorbell 37 may generate video content using a camera and/or audio content using a microphone. In this instance, smart doorbell 37 may output the video content and audio content to hub device 12, which may forward the video content and/or audio content to mobile device 32.

Outdoor air sensor 38 may be configured to generate sensor data indicating, for example, a temperature, humidity, and/or quality (e.g., carbon monoxide, particulate matter, or other hazards) of the surrounding air. In some examples, outdoor air sensor 38 may wireless transmit the sensor data to hub device 12. For instance, outdoor air sensor 38 may periodically output a current or average temperature to thermostats 24 via hub device 12.

Outdoor passive infrared sensors 40 may include security devices configured to detect the presence of a nearby object, such as a person, based on detecting infrared wavelength electromagnetic waves emitted by the object. In response to detecting the infrared waves, passive infrared sensors 40 may generate sensor data indicating the presence of the object, and wirelessly transmit the sensor data to hub device 12. Hub device 12 may be configured to perform an action in response to receiving the sensor data, such as outputting an alert, such as a notification to mobile device 32, or by outputting a command for the respective passive infrared sensor 40 to output an audible or visual alert.

System 20 may include various devices, including, for example, a security device, a water heater, a water flow controller, a garage door controller, or other devices. For example, system 20 may include one or more of: a door contact sensor, a motion passive infrared (PIR) sensor, a mini contact sensor, a key fob, a smoke detector, a glass break detector, a siren, a combined smoke detector and Carbon monoxide (CO) detector, an indoor siren, a flood sensor, a shock sensor, an outdoor siren, a CO detector, a wearable medical pendant, a wearable panic device, an occupancy sensor, a keypad, and/or other devices.

In accordance with the techniques of the disclosure, a device, such as central hub device 12 or a remote device not pictured, may determine a scan value resulting from a network scan. The device may compare the scan value to a predetermined scan value threshold. In response to the scan value meeting the predetermined scan value threshold, the device may determine a presence of an electromagnetic interference source at or near a premise. The device may generate a premise map that includes an indication of a location at the premise of the electromagnetic interference source.

Techniques described herein may improve a performance of a network. For example, a device that performs the prediction described herein may address potential issues in a local premise network that the user was previously unaware of. This may reduce the downtimes experienced when the failures ultimately occur, the time and effort to discover the interference after the occurrence of the failure, and the loss in efficiency experienced by the interference.

Furthermore, both an installer and a user can easily locate the source and location of electromagnetic interference when there is problem at a customer's location due to interference sources. For instance, a dealer can remotely check and solve the customer complaints, which can save cost and time. Additionally, electromagnetic interference can cause batteries in sensors (e.g., one or more of thermostats 24, motion sensors 26, door/window contact sensor 28, air vent dampers 36, smart doorbell 37, outdoor air sensor 38, and infrared sensors 40) and hubs (e.g., hub device 12) to drain, meaning the techniques of this disclosure can allow these devices to avoid the fast draining of batteries by informing the user to move or remove the high interference sources from the affected zone area. Electromagnetic interference can also cause supervision failure, so the techniques described herein can identify and remove the interference source prior to experiencing critical supervision failures. The interference level can be easily visualized as a different zone category (e.g., low interference, medium interference, high interference, etc.) with available data. The techniques described herein also allow installers to run the interference diagnostic mode and find locations that have higher interference zones for certain durations of time (e.g., 24 hours).

FIG. 2B is a block diagram illustrating an example computing device configured to detect whether one or more sensor devices or hub devices in a local premise network are experiencing, or are likely to experience, electromagnetic interference, in accordance with one or more aspects of the techniques described in this disclosure. Computing device 210 of FIG. 2B is described below as an example of computing device 110 of FIG. 1. FIG. 2B illustrates only one particular example of computing device 210, and many other examples of computing device 210 may be used in other instances and may include a subset of the components included in example computing device 210 or may include additional components not shown in FIG. 2B.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2B, computing device 210 includes user interface component (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include mapping module 220, communication module 222, and premise map data 226.

One or more processors 240 may implement functionality and/or execute instructions associated with computing device 210 to utilize premise map data 226 and various scan values to detect electromagnetic interference. That is, processors 240 may implement functionality and/or execute instructions associated with computing device 210 to receive various pieces of data from one or more different sources and detect a potential area within premise map data 226 that may be experiencing electromagnetic interference.

Examples of processors 240 include application processors, display controllers, auxiliary processors, one or more sensor hubs, and any other hardware configure to function as a processor, a processing unit, or a processing device. Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to utilize one or more scan values to detect possible electromagnetic interference in a premise network.

Mapping module 220 may execute locally (e.g., at processors 240) to provide functions associated with detecting electromagnetic interference. In some examples, prediction module 220 may act as an interface to a remote service accessible to computing device 210. For example, prediction module 220 may be an interface or application programming interface (API) to a remote server that applies utilizes received scan values to make a determination as to whether electromagnetic interference is present in a location within a premise map in premise map data 226, as well as what specific location may include the source of the electromagnetic interference.

In some examples, communication module 222 may execute locally (e.g., at processors 240) to provide functions associated with communicating with outside devices. In some examples, communication module 222 may act as an interface to a remote service accessible to computing device 210. For example, communication module 222 may be an interface or application programming interface (API) to a remote server that analyzes receives the data used by mapping module 220 to determine the electromagnetic interference information, as well as transmit the generated premise map.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222, and premise map data 226. Storage components 248 may include a memory configured to store data or other information associated with modules 220 and 222, and premise map data 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may work with communication module 222 communicate with external devices via one or more wired and/or wireless networks by transmitting and/or receiving network signals on one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, includes a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras) one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, includes a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality:

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, communication module 222 may determine a scan value resulting from a network scan. In some instances, the scan value may include one or more of a sensor device electromagnetic energy scan value resulting from a sensor device electromagnetic scan, a hub device IEEE 802.11 detection scan value resulting from a hub device IEEE 802.11 detection scan, and a hub device IEEE 802.15.4 detection scan value resulting from a hub device IEEE 802.15.4 detection scan. Additionally or alternatively, such as in instances when the premise includes a TDMA network, the scan value could be one or more of an indication of whether a sensor device lost synchronization and then later regained synchronization, a number of times the sensor device lost synchronization and then later regained synchronization, a number of non-TDMA messages detected at or near the premise, a number of free channels to which communication can be migrated to, and an energy level of channels different than a current channel over which communication is occurring.

When the scan value includes beacon losses, the scan value could indicate a back message. For instance, a back message could mean that a sensor completely lost synchronization (e.g., X consecutive beacon losses), and then at some later point regains synchronization. When the scan value includes a number of Non-TDMA messages, the scan value indicates that the sensor may not be able to sync to a beacon, so the sensor cannot transmit messages in its allocated slot. This means that the sensor will try to send the message in non-TDMA format, indicating that there is electromagnetic interference around the sensor.

When the scan value includes a sensor device energy scan value, the scan value could indicate a jam message. The sensor performs an energy scan and stores energy value. When the energy value is above a threshold, that could be a red flag. This is helpful because mapping module 220 can detect interference when the end device back message and non-TDMA messages are not occurring, but simply due to scanning for energy from anything in the vicinity of the sensor.

When the scan value includes WiFi scan information from the hub device, the hub device performs a WiFi scan to recognize potentially problematic WiFi sources (e.g., a WiFi router) by looking for WiFi protocol and frequency band. This scan value may be measured in decibels (dB).

When the scan value includes a 15.4 scan value, the hub device may perform a scan for 15.4 energy sources (e.g., smart home appliances and devices). In essence, the hub device is looking for energy sources other than WiFi sources.

When the scan value includes a frequency agility to change channels, the hub device looks for other free channels to migrate to. It may be possible that there are so many 15.4 systems around the hub device that every channel of the system is occupied. If all channels are occupied, the hub device may create an error message that no free channels are available. The hub device may also generate an error message for access points looking for channels. The scan value may be measured as an energy and finds the energy above a threshold.

Mapping module 220 may compare the scan value to a predetermined scan value threshold. In response to the scan value meeting the predetermined scan value threshold, mapping module 220 may determine a presence of an electromagnetic interference source at or near a premise.

In some instances, such as when there are multiple zones at the premise, mapping module 220 may determine, based on the scan value, the location at the premise of the electromagnetic interference source. For instance, when the scan value includes a sensor device electromagnetic energy scan value, mapping module 220 may determine a sensor device that was subjected to the network scan to produce the sensor device electromagnetic energy scan value. Mapping module 220, using premise map data 226, may determine a location of the sensor device, such as which zone on the premise the sensor device is located. Mapping module 220 may then determine that the location at the premise of the electromagnetic interference source is the location or zone of the sensor device.

In other instances, such as when the scan value includes one or more of a hub device IEEE 802.11 detection scan value and a hub device IEEE 802.15.4 detection scan value, mapping module 220 may determine which hub device was subjected to the network scan to produce the one or more of the hub device IEEE 802.11 detection scan value and the hub device IEEE 802.15.4 detection scan value. Mapping module 220 may then determine a location of the hub device and determine that the location at the premise of the electromagnetic interference source comprises the location of the hub device.

In some instances, there may be multiple thresholds for a single type of scan value. For instance, there may be a low predetermined scan value threshold and a high predetermined scan value threshold. In such instances, in comparing the scan value to the predetermined scan value threshold, mapping module 220 may compare the scan value to the low predetermined scan value threshold and compare the scan value to a high predetermined scan value threshold. The high predetermined scan value threshold may be more extreme than the low predetermined scan value threshold, meaning that the high predetermined scan value threshold may be greater than the low predetermined scan value threshold when a high value indicates more electromagnetic interference, and that the high predetermined scan value threshold may be lesser than the low predetermined scan value threshold when a low value indicates more electromagnetic interference.

In response to the scan value meeting each of the low predetermined scan value threshold and the high predetermined scan value threshold, mapping module 220 may determine a presence of high electromagnetic interference at the electromagnetic interference source at or near the premise. In response to the scan value meeting the low predetermined scan value threshold and the scan value failing to meet the high predetermined scan value threshold, mapping module 220 may instead determine a presence of low electromagnetic interference at the electromagnetic interference source at or near the premise. Scan value failing to meet either threshold would indicate a lack of electromagnetic interference.

In some further instances, there may also be a medium predetermined scan value threshold between the low predetermined scan value threshold and the high predetermined scan value threshold. In such instances, mapping module 220 may further compare the scan value to the medium predetermined scan value threshold. In response to the scan value meeting each of the low predetermined scan value threshold and the medium predetermined scan value threshold and the scan value failing to meet the high predetermined scan value threshold, mapping module 220 may determine a presence of medium electromagnetic interference at the electromagnetic interference source at or near the premise. As such, mapping module 220 determining the presence of the high electromagnetic interference would indicate that the scan value meets each of the low predetermined scan value threshold, the medium predetermined scan value threshold, and the high predetermined scan value threshold. Furthermore, mapping module 220 determining the presence of the low electromagnetic interference would indicate that the scan value meets the low predetermined scan value threshold and the scan value fails to meet each of the medium predetermined scan value threshold and the high predetermined scan value threshold.

Mapping module 220 may generate a premise map that includes an indication of a location at the premise of the electromagnetic interference source. When multiple thresholds are used, mapping module 220 may further generate the indication of the location at the premise of the electromagnetic interference source to graphically indicate whether the electromagnetic interference source is producing the low electromagnetic interference, the medium electromagnetic interference, or the high electromagnetic interference.

Communication module 222 may output, for display on a display device, a graphical indication of the premise map and the indication of the location at the premise of the electromagnetic interference source. In instances where computing device 210 is a hub device or a mobile device (e.g., owned by a service technician or a user that occupies the premise), communication module 222 may output the graphical indication of the premise map locally on display component 202. In instances where computing device 210 is a remote server device, communication module 222 may output the graphical indication by transmitting the graphical indication to a hub device or a mobile device.

In some instances, scan values can be evaluated and compared over time. For instance, when the scan value is a first scan value resulting from a first network scan performed at a first time, communication module 222 may determine a second scan value resulting from a second network scan performed at a second time later than the first time. Mapping module 220 may compare the second scan value to the first scan value. In response to the second scan value differing from the first scan value by a predetermined threshold amount (e.g., the second scan value is greater than the first scan value by some threshold amount), mapping module 220 may determine an increased presence of the electromagnetic interference source at or near the premise. As such, when mapping module 220 generates the premise map, the premise map may include an indication of a location at the premise of the increased presence of the electromagnetic interference source, in addition to or in lieu of any other graphical indications.

When the system includes multiple scan values, the presence of electromagnetic interference in a particular zone may be determined in a number of different ways. For instance, weights can be assigned to each different scan value or comparison result, and the combined set of weighted results may be compared to another threshold to determine the ultimate presence and/or level of electromagnetic interference. In other instances, a highest determined level of electromagnetic interference may be the controlling and shown level of electromagnetic interference. In still other instances, the different value types can be additive, with zones having multiple instances of low or medium levels of electromagnetic interference could cause mapping module 220 to determine that the zone has a high level of electromagnetic interference.

In some instances, communication module 222 may send the generated premise map, along with additional indications of interference, to a remote server device for evaluation and/or logging. This may enable servicers or installers to analyze the premise map and contact a user occupying the premise with recommendations for fixing the electromagnetic interference issue to avoid quick battery drain issues or supervision failure issues.

In accordance with the techniques of this disclosure, Techniques described herein may improve a performance of a network. For example, a device that performs the prediction described herein may address potential issues in a local premise network that the user was previously unaware of. This may reduce the downtimes experienced when the failures ultimately occur, the time and effort to discover the interference after the occurrence of the failure, and the loss in efficiency experienced by the interference.

Furthermore, both an installer and a user can easily locate the source and location of electromagnetic interference when there is problem at a customer's location due to interference sources. For instance, a dealer can remotely check and solve the customer complaints, which can save cost and time. Additionally, electromagnetic interference can cause batteries in sensors and hubs to drain, meaning the techniques of this disclosure can allow these devices to avoid the fast draining of batteries by informing the user to move or remove the high interference sources from the affected zone area. Electromagnetic interference can also cause supervision failure, so the techniques described herein can identify and remove the interference source prior to experiencing critical supervision failures. The interference level can be easily visualized as a different zone category (e.g., low interference, medium interference, high interference, etc.) with available data. The techniques described herein also allow installers to run the interference diagnostic mode and find locations that have higher interference zones for certain durations of time (e.g., 24 hours).

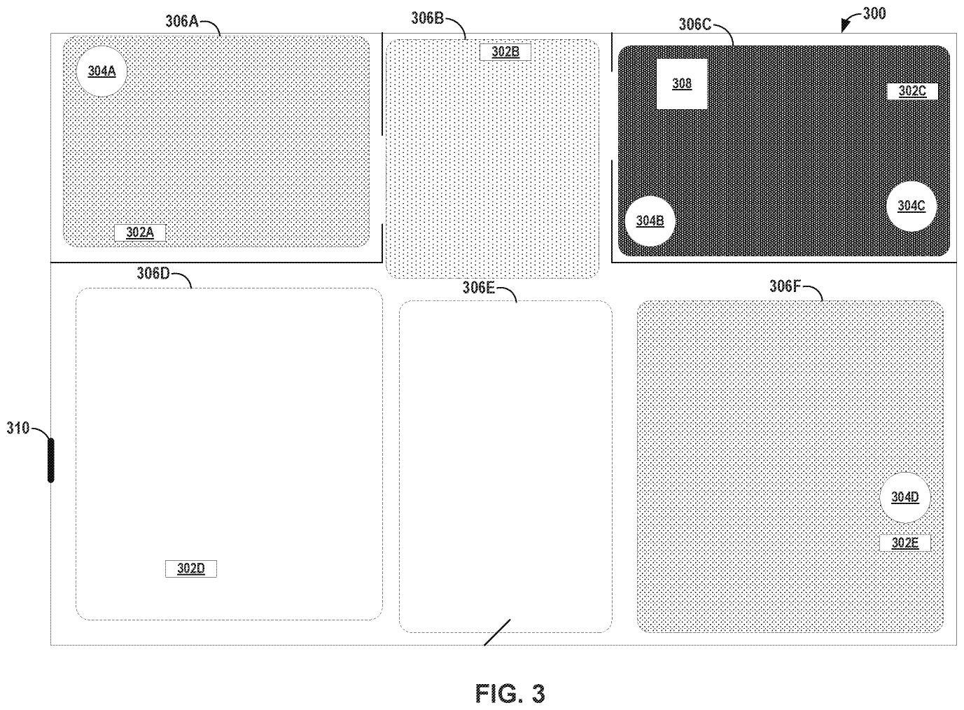

FIG. 3 is a conceptual diagram illustrating an example premise map 300, in accordance with some examples of this disclosure. In the example of FIG. 3, the premise may include multiple examples of different sensors. For instance, sensors 302A-302E may each be smoke detectors, while sensors 304A-30D may be motion sensors. However, the techniques described herein would be applicable to any type of sensor included in this disclosure, including additional sensors, fewer sensors, or different types of sensors. The premise also includes hub device 310 and wireless router 308. Each of devices 302A-302E, 304A-304D, 308, and 310 may be wirelessly connected over some type of premise wireless network, as described throughout this disclosure.

Premise map 300 may include either a two- or three-dimensional depiction of a floorplan for the premise, either created by the user through inputs at hub device 310 or by uploading an indication of the floorplan to a remote server device that performs the electromagnetic interference detection described herein. In other examples, the device that performs the techniques described herein (e.g., hub device 310 or a remote server device) may assemble an approximation of the premise by detecting energy levels from each of the sensors 302A-302E and 304A-304D in the signal received by hub device 310 from sensors 302A-302E and 304A-304D. In this example, the approximation would include distances and predicted obstacles between sensors 302A-302E and 304A-304D and hub device 310, taken in relation to hub device 310.

Similarly, the device that performs the techniques described herein may dynamically create the zones within the received or approximated floorplan, the received or approximated floorplan being automatically segmented based on groups of sensors within close proximity to one another. For instance, zones 306A-306F may be created to account for walls in the floorplan that may create rooms, or may create a grid of static-sized blocks that adequately fit the space. In other examples, the user themselves may define the number of zones and the locations of each zone.

In accordance with the techniques described herein, hub device 310 (or a remote server) may receive scan values from a network scan performed locally within the premise. For instance, hub device 310 may instruct one or more of sensors 302A-302E and 304A-304D to perform an electromagnetic scan to detect electromagnetic energy in the immediate vicinity of the respective sensor. Hub device 310 may also perform one or more of an IEEE 802.11 detection scan and an IEEE 802.15.4 detection scan in the immediate vicinity of hub device 310. Each of these scans may produce respective scan values, which are sent to hub device 310. In the example of FIG. 3, hub device 310 itself may analyze these scan values, but other instances may include hub device 310 forwarding these scan values to a remote server for evaluation. Hub device 310 may also include other data points in the analysis, such as an indication of whether a sensor device lost synchronization and then later regained synchronization or a number of times the sensor device lost synchronization and then later regained synchronization.

In analyzing the scan values, hub device 310 may compare the respective scan values to various thresholds having a corresponding type to the scan value. For instance, each type of scan value may have a low threshold past which at least low electromagnetic interference is presumed to be present, a medium threshold past which at least medium electromagnetic interference is presumed to be present, and a high threshold past which at least high electromagnetic interference is presumed to be present. However, in other instances, additional thresholds or fewer thresholds may be used to signify the level of electromagnetic interference.

For zone 306A, which includes sensors 302A and 304A, hub device 310 may determine that there is a medium amount of electromagnetic interference. While there are only the two sensors in zone 306A, the walls separating sensors 302A and 304A from wireless router 308 and hub device 310. Additionally, the close proximity of sensors 302A and 304A may lead to a certain amount of energy in the scans for each of sensors 302A and 304A. This may lead to a higher amount of lost beacons and lost synchronization, causing hub device 310 to determine that there is a medium amount of electromagnetic interference in zone 306A.

For zone 306B, which includes sensor 302B, hub device 310 may determine that there is a low amount of electromagnetic interference. With only one sensor in zone 306B and only a partial wall blocking a direct line from sensor 302B and hub device 310, there may be minimal interference in the immediate vicinity of sensor 302B.

For zone 306C, which includes sensors 302C, 304B, and 304C, as well as wireless router 308, hub device 310 may determine that there is a high amount of electromagnetic interference. The presence of three sensors, as well as a wireless router, in a small enclosed room may lead to a high amount of energy in the vicinity of each of sensors 302C, 304B, and 304C and a high loss of synchronization between sensors 302C, 304B, and 304C and hub device 310. With the knowledge of the floor plan and the placement of various devices, a user may easily discern that moving wireless router 308 to a different zone of the premise may solve the high electromagnetic interference issue in zone 306C, which may previously have gone undetected.

For zone 306D, which includes hub device 310 and sensor 302D, hub device 310 may determine that there is no electromagnetic interference. With the openness of the area in zone 306D and the singular sensor device, hub device 310 may determine that none of the scan values reach a threshold of indicating electromagnetic interference.

For zone 306E, no sensor devices are present. As such, hub device 310 may determine that none of the scan values reach a threshold of indicating electromagnetic interference, indicating that there is no electromagnetic interference.

For zone 306F, which includes sensors 302E and 304D, hub device 310 may determine that there is a medium amount of electromagnetic interference. While there are only the two sensors in zone 306F, there may be additional devices in zone 306F, such as kitchen appliances, cabinets, televisions, gaming systems, cable boxes, or other devices crowding the space and causing artificial noise amongst the sensors in zone 306F. Additionally, the close proximity of sensors 302A and 304A may lead to a certain amount of energy in the scans for each of sensors 302A and 304A. This may lead to hub device 310 determining that there is a medium amount of electromagnetic interference in zone 306F.

Once hub device 310 makes the various determinations, hub device 310 may generate premise map 300. Premise map 300 may include visual indications of each of zones 306A-306F, with a distinguishing feature indicating whether the respective zone has no electromagnetic interference, low electromagnetic interference, medium electromagnetic interference, or high electromagnetic interference. In other examples, the number of thresholds could indicate the number of different levels of electromagnetic interference indications (e.g., the number of thresholds plus one). In still other examples, the visual indication may be a gradient as the scan value approaches, meets, and surpasses the respective threshold. In some instances, such as the example of FIG. 3, the visual indication of the level of electromagnetic interference may be a pattern that gets darker as more electromagnetic interference is detected. In other instances, a green-yellow-red system may be used to indicate the level of electromagnetic interference. Ultimately, any visual system that clearly delineates the levels of electromagnetic interference could be used by hub device 310 to generate premise map 300. In some instances, hub device 310 may also include one or more of visual indications of the various sensors 302A-302E and 304A-304D, a visual indication of other IoT devices on the premise (such as wireless router 308), a visual indication of hub device 310, and a visual indication of the two- or three-dimensional floorplan.

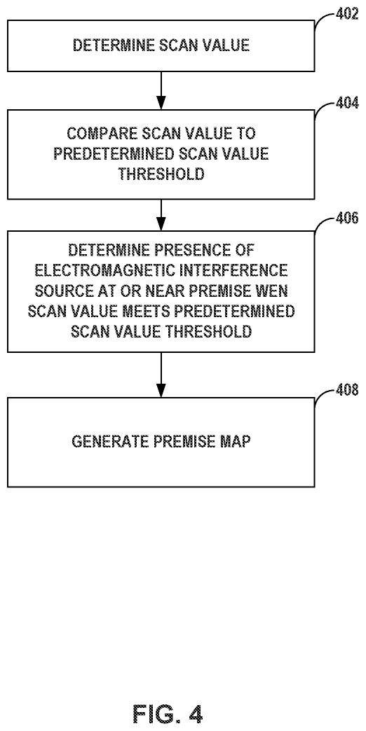

FIG. 4 is a flow chart illustrating an example mode of operation. The techniques of FIG. 4 may be performed by one or more processors of a computing device, such as computing device 110 of FIG. 1 and/or computing device 210 illustrated in FIG. 2. For purposes of illustration only, the techniques of FIG. 4 are described within the context of computing device 210 of FIG. 2, although computing devices having configurations different than that of computing device 210 may perform the techniques of FIG. 4.

Communication module 222 determines a scan value resulting from a network scan, either by receiving the scan value from another device or by conducting the network scan itself (402). Mapping module 220 compares the scan value to a predetermined scan value threshold (404). In response to the scan value meeting the predetermined scan value threshold, mapping module 220 determines a presence of an electromagnetic interference source at or near a premise (406). Mapping module 220 generates a premise map that includes an indication of a location at the premise of the electromagnetic interference source (408).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method comprising the steps of:
determining a scan value resulting from a network scan;
comparing the scan value to a predetermined scan value threshold;
in response to the scan value meeting the predetermined scan value threshold, determining a presence of an electromagnetic interference source at or near a premise; and
generating a premise map that includes an indication of a location at the premise of the electromagnetic interference source.

2. The method of claim 1, wherein the scan value comprises one or more of:
a sensor device electromagnetic energy scan value,
a hub device IEEE 802.11 detection scan value, and
a hub device IEEE 802.15.4 detection scan value.

3. The method of claim 1, wherein determining the scan value comprises performing one or more of:
a sensor device electromagnetic scan,
a hub device IEEE 802.11 detection scan, and
a hub device IEEE 802.15.4 detection scan.

4. The method of claim 1, further comprising:
outputting, for display on a display device, a graphical indication of the premise map and the indication of the location at the premise of the electromagnetic interference source.

5. The method of claim 1, wherein comparing the scan value to the predetermined scan value threshold comprises comparing, by a hub device, the scan value to the predetermined scan value threshold.

6. The method of claim 1, wherein comparing the scan value to the predetermined scan value threshold comprises comparing, by a server device located outside of the premise, the scan value to the predetermined scan value threshold.

7. The method of claim 1, wherein the scan value comprises one or more of:
an indication of whether a sensor device lost synchronization and then later regained synchronization,
a number of times the sensor device lost synchronization and then later regained synchronization,
a number of non-TDMA messages detected at or near the premise,
a number of free channels to which communication can be migrated to, and
an energy level of channels different than a current channel over which communication is occurring.

8. The method of claim 1, wherein the scan value comprises a first scan value resulting from a first network scan performed at a first time, and wherein the method further comprises:
determining a second scan value resulting from a second network scan performed at a second time later than the first time;
comparing the second scan value to the first scan value;
in response to the second scan value differing from the first scan value by a predetermined threshold amount, determining an increased presence of the electromagnetic interference source at or near the premise; and
generating the premise map that includes an indication of a location at the premise of the increased presence of the electromagnetic interference source.

9. The method of claim 1, further comprising:
determining, based on the scan value, the location at the premise of the electromagnetic interference source.

10. The method of claim 9, wherein determining the location at the premise of the electromagnetic interference source comprises, when the scan value includes a sensor device electromagnetic energy scan value:
determining a sensor device that was subjected to the network scan to produce the sensor device electromagnetic energy scan value;
determining a location of the sensor device; and
determining that the location at the premise of the electromagnetic interference source comprises the location of the sensor device.

11. The method of claim 9, wherein determining the location at the premise of the electromagnetic interference source comprises, when the scan value includes one or more of a hub device IEEE 802.11 detection scan value and a hub device IEEE 802.15.4 detection scan value:
determining a hub device that was subjected to the network scan to produce the one or more of the hub device IEEE 802.11 detection scan value and the hub device IEEE 802.15.4 detection scan value;
determining a location of the hub device; and
determining that the location at the premise of the electromagnetic interference source comprises the location of the hub device.

12. The method of claim 1, wherein the predetermined scan value threshold comprises a low predetermined scan value threshold, and wherein comparing the scan value to the predetermined scan value threshold comprises:
comparing the scan value to the low predetermined scan value threshold;
comparing the scan value to a high predetermined scan value threshold, wherein the high predetermined scan value threshold is more extreme than the low predetermined scan value threshold;
in response to the scan value meeting each of the low predetermined scan value threshold and the high predetermined scan value threshold, determining a presence of high electromagnetic interference at the electromagnetic interference source at or near the premise; and
in response to the scan value meeting the low predetermined scan value threshold and the scan value failing to meet the high predetermined scan value threshold, determining a presence of low electromagnetic interference at the electromagnetic interference source at or near the premise.

13. The method of claim 12, further comprising:
comparing the scan value to a medium predetermined scan value threshold, wherein the medium predetermined scan value threshold is between the low predetermined scan value threshold and the high predetermined scan value threshold; and
in response to the scan value meeting each of the low predetermined scan value threshold and the medium predetermined scan value threshold and the scan value failing to meet the high predetermined scan value threshold, determining a presence of medium electromagnetic interference at the electromagnetic interference source at or near the premise.

14. The method of claim 13,
wherein determining the presence of the high electromagnetic interference comprises determining the presence of the high electromagnetic interference in response to the scan value meeting each of the low predetermined scan value threshold, the medium predetermined scan value threshold, and the high predetermined scan value threshold, and
wherein determining the presence of the low electromagnetic interference comprises determining the presence of the low electromagnetic interference in response to the scan value meeting the low predetermined scan value threshold and the scan value failing to meet each of the medium predetermined scan value threshold and the high predetermined scan value threshold.

15. The method of claim 14, further comprising:
generating the indication of the location at the premise of the electromagnetic interference source to graphically indicate whether the electromagnetic interference source is producing the low electromagnetic interference, the medium electromagnetic interference, or the high electromagnetic interference.

16. The method of claim 1, wherein the premise includes a time division multiple access (TDMA) protocol-enabled wireless network.

17. A device comprising:
one or more communication units configured to receive, from a hub device of a premise wireless network, a scan value resulting from a network scan of the premise wireless network; and
one or more processors configured to:
compare the scan value to a predetermined scan value threshold;
in response to the scan value meeting the predetermined scan value threshold, determine a presence of an electromagnetic interference source at or near a premise that includes the premise wireless network; and
generate a premise map that includes an indication of a location at the premise of the electromagnetic interference source.

18. The device of claim 17, wherein the one or more communication units are further configured to send the premise map to the hub device for display on a display device operatively connected to the hub device.

19. A system comprising:
a plurality of sensor devices; and
one or more hub devices including a first hub device, wherein the first hub device is configured to:
determine a scan value resulting from a network scan;
compare the scan value to a predetermined scan value threshold;
in response to the scan value meeting the predetermined scan value threshold, determine a presence of an electromagnetic interference source at or near a premise; and
generate a premise map that includes an indication of a location at the premise of the electromagnetic interference source.

20. The system of claim 19, wherein the scan value comprises one or more of:
a sensor device electromagnetic energy scan value for a first sensor device of the plurality of sensor devices,
a hub device IEEE 802.11 detection scan value for one of the one or more hub devices, and
a hub device IEEE 802.15.4 detection scan value for one of the one or more hub devices.
